(19) United States
(12) Patent Application Publication
(10) Pub. No.: US 2025/0343458 A1
(43) Pub. Date: Nov. 6, 2025

(54) Multi-Layer Edgewise Coil

(71) Applicant: Tecnotion Assets B.V., Almelo (NL)

(72) Inventors: Erwin Gerardus Bernardus Hofste, Almelo (NL); Dennis Buter, Almelo (NL)

(21) Appl. No.: 18/870,664

(22) PCT Filed: May 31, 2023
(86) PCT No.: PCT/NL2023/050305

§ 371 Date: Nov. 30, 2024

(30) Foreign Application Priority Data
May 31, 2022 (NL) 2032028

(51) Int. Cl. H02K 3/04; H02K 15/04

(52) U.S. Cl. CPC H02K 3/04; H02K 15/04

(57) ABSTRACT

The present invention relates to an assembly for winding an edgewise coil. The present invention further relates to a multi-layer edgewise coil. The assembly comprising a winding core. at least one wire guiding unit for receiving a wire. a first pressing unit, and a drive shaft for rotating the winding core relative to the at least one wire guiding unit. The at least one wire guiding unit comprises a channel for guiding the wire that follows at least a part of a circumference of the winding core. preferably over an angle exceeding 30 degrees. The assembly is configured for operating in a first mode in which mode the first pressing unit presses. in a direction from the first end surface to the second end surface. onto a second side surface of the wire arranged on the winding core at least during winding of a first layer of the wire on the winding core by means of rotating the winding core relative to the at least one wire guiding unit.

The present invention relates to an assembly for winding an edgewise coil. The present invention further relates to a multi-layer edgewise coil.

Electric coils are known in the art and are generally used for generating magnetic fields and/or for generating force or torque in electric motors such as linear motors. An electric coil is typically formed by winding a wire around a winding core. An edgewise coil is a particular example of an electric coil.

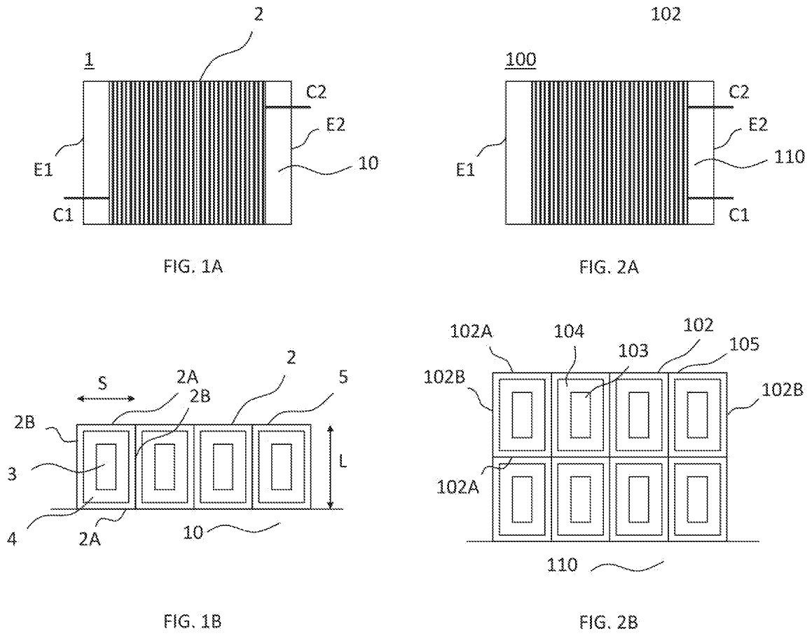

FIG. 1A illustrates a known edgewise coil 1. For this type of coil, a particular type of wire 2 is used that is shown in more detail in FIG. 1B. Wire 2 comprises a conductive inner core 3, for example made of copper. Around inner core 3 an insulation layer 4 is arranged to prevent adjacent turns in coil 1 from making direct electrical contact. Wire 2 further comprises a surrounding layer 5 that is arranged around insulating layer 4. Surrounding layer 5 is typically made of a thermoplastic material.

Wire 2 has a substantially rectangular cross section. Furthermore, wire 2 has first side surfaces 2A and second side surfaces 2B that correspond to short edges S and long edges L of the cross section, respectively. As shown in FIG. 1B, wire 2 is arranged with one of its first side surfaces 2A on winding core 10.

To manufacture coil 1, wire 2 is wound around winding core 10. After having wound wire 2, the combination of winding core 10 and wire 2 is subjected to a heating step. During this step, surrounding layer 5 will melt thereby forming a body of surrounding layer 5 in which conductive inner cores 3 and insulating layers 4 are fixated in spaced apart manner.

Important factors for edgewise coils are the copper fill factor and the heat conducting capability. Compared to coils in which the wire is arranged with one of its second side surfaces 2B on winding core 10, edgewise coils offer the possibility to generate more force or torque and provide a better thermal conductivity per unit volume.

A continuous demand exists for coils offering a higher copper fill factor and/or coils that allow the generation of higher forces or torques.

According to the present invention, this object is achieved using the assembly for winding an edgewise coil as defined in claim 1. The assembly comprises a winding core, and at least one wire guiding unit for receiving a wire that has a substantially rectangular cross section. The wire has first side surfaces and second side surfaces that correspond to short and long edges of the cross section, respectively. The at least one wire guiding unit is configured for arranging the wire with one of its first side surfaces on the winding core.

The assembly further comprises a drive shaft for rotating the winding core relative to the at least one wire guiding unit. Here it is noted that the present invention relates to embodiments in which the winding core is rotated relative to a stationary at least one wire guiding unit, to embodiments in which the at least one wire guiding unit is rotated relative to a stationary winding core, and to embodiments in which both the winding core and the at least one wire guiding unit are both rotating relative to each other.

The winding core has a first end surface and a second end surface that are opposite to each other in a direction parallel to the drive shaft. The assembly further comprises a first pressing unit.

The at least one wire guiding unit comprises a channel for guiding the wire that follows at least a part of a circumference of the winding core, preferably over an angle exceeding 30 degrees. Moreover, the assembly is configured for operating in a first mode in which mode the first pressing unit presses, in a direction from the first end surface to the second end surface, onto a second side surface of the wire arranged on the winding core at least during winding of a first layer of the wire on the winding core by means of rotating the winding core relative to the at least one wire guiding unit.

The assembly of the present invention enables the manufacturing of edgewise coils using relatively thin wires. For example, the wire may have a width, corresponding to the long edges of the cross section, that lies in a range between 0.5 and 6 mm, preferably in a range between 1 and 3 mm, and the wire may have a thickness, corresponding to the short edges of the cross section, that lies in between 0.05 and 1 mm, preferably between 0.1 and 0.5 mm.

The channel preferably follows a circumference of the winding core over an angle that exceeds 60 degrees, more preferably 80 degrees. The angle over which the channel follows the circumference should be sufficiently large to allow the wire to deform such that it can be arranged properly on the winding core. Using the channel as described above allows relatively thin wire to be used without increasing a risk of wrinkling occurring in the wire during winding thereof on the winding core.

A size of the cross section of the channel preferably corresponds to a size of the wire. The size of the channel may for example be only slightly larger than the cross section of the wire to allow the wire to be transported through the channel, while simultaneously deforming the wire in a controlled manner. In other embodiments, the size of the channel can be slightly smaller than the cross section of the wire to enforce a given shape and/or size of wire before applying it onto the winding core by deforming the wire inside the channel.

The at least one wire guiding unit may comprise a first wire guiding unit of which the channel is configured for bending the first surfaces of the wire such that the first surfaces obtain a curvature that corresponds to a curvature of the winding core. By having the channel following the circumference as described above over an angle that is sufficiently large, the risk of the wire partially deforming back to its original shape after leaving the wire guiding unit can be mitigated.

The first wire guiding unit may comprise a groove in a bottom surface of the first wire guiding unit that faces the winding core. This groove forms the channel of the first wire guiding unit. As an example, the first wire guiding unit may comprise a first plate member, a second plate member, and a first intermediate plate member arranged in between the first and second plate members. An end second section of the first and second plate members extends farther towards the winding core than the first intermediate plate member. Mutually facing side surfaces of the end sections of the first and second plate members form sidewalls of the channel. An edge of the first intermediate plate facing the winding core forms an upper wall of the channel and the winding core forms a lower wall of the channel when the assembly operates in the first mode. The first wire guiding unit can be fixedly attached to the first pressing unit.

The first pressing unit may comprise a first pressing body having a first central bore in which the first end surface of the winding core is arranged during at least part of operating in the first mode, and a first spring for exerting a spring force onto the first pressing body. Using the first pressing unit, pressure can be exerted onto the wire while it is being wound onto the winding core. The first pressing body can be configured, when the assembly operates in the first mode, to be pushed by the wire that is arranged on the winding core in the direction from the second end surface to the first end surface thereby compressing the first spring.

The first central bore may have an inner diameter that corresponds to diameter of the winding core.

The assembly may further comprise a supporting shaft that is rotationally coupled to the drive shaft. The supporting shaft can be configured to be decouplable from the drive shaft. Furthermore, the supporting shaft may at least partially extend in the first central bore of the first pressing unit.

The assembly may further comprise a first spring support mounted to the supporting shaft when the assembly operates in the first mode. In this case, the first spring is mounted in between the first spring support and the first pressing unit when the assembly operates in the first mode.

The assembly can be operable in a second mode following the first mode. In this case, the assembly may further comprise a first clamping member mounted to or at the first end surface of the winding core at least when the assembly operates in the second mode. The first clamping member can be configured to exert a clamping force, in a direction from the first end surface to the second end surface, onto a second side surface of the wire arranged on the winding core.

When switching from operating in the first mode to operating in the second mode, the supporting shaft may be decoupled from the drive shaft. This allows a user to remove the first pressing unit and to allow the first clamping member to be placed for maintain sufficient pressure on the wire on the winding core.

The assembly may further comprise a second pressing unit, wherein, when the assembly operates in the second mode, the second pressing unit presses, in a direction from the second end surface to the first end surface, onto a second side surface of the wire arranged on the winding core at least during winding of a second layer of the wire on the winding core by means of rotating the winding core. The at least one guiding unit may comprise a second wire guiding unit of which the channel is configured for bending the first surfaces of the wire such that the first surfaces obtain a curvature that corresponds to a curvature of the combination of the winding core and the first layer of wire arranged on the winding core.

The second wire guiding unit may comprise a groove in a bottom surface of the second wire guiding unit that faces the winding core, said groove forming the channel of the second wire guiding unit. As an example, the second wire guiding unit may comprise a third plate member, a fourth plate member, and a second intermediate plate member arranged in between the third and fourth plate members. An end second section of the third and fourth plate members extends farther towards the winding core than the second intermediate plate member. Mutually facing side surfaces of the end sections of the third and fourth plate members form sidewalls of the channel, wherein an edge of the second intermediate plate facing the winding core forms an upper wall of the channel and the first layer of the wire arranged on the winding core a lower wall of the channel when the assembly operates in the second mode. The second wire guiding unit can be fixedly attached to the second pressing unit.

The second pressing unit may comprise a second pressing body having a second central bore in which the second end surface of the winding core is arranged during at least part of operating in the second mode, and a second spring for exerting a spring force onto the second pressing body. The second central bore may have an inner diameter that corresponds to diameter of the combination of the winding core and the first layer of wire.

The second pressing body can be configured, when the assembly operates in the second mode, to be pushed by the wire that is arranged on the winding core in the direction from the first end surface to the second end surface thereby compressing the second spring. The assembly may further comprise a second spring support mounted to the drive shaft when the assembly operates in the second mode, wherein the second spring is mounted in between the second spring support and the second pressing unit when the assembly operates in the second mode.

The assembly can be operable in a third mode in which the second pressing unit has been removed from the second end surface of the winding core, the assembly further comprising a second clamping member mountable to or at the second end surface of the winding core, wherein the second clamping member is configured to exert a clamping force, in a direction from the second end surface to the first end surface, onto a second side surface of the wire arranged on the winding core at least during operating in the second mode.

The winding core may comprise a groove for allowing an end of the wire to be clamped prior to operating in the first mode. A user may for example mount a first end of the wire in the groove, while the opposing second end of the wire is still present on or in the wire supply.

The wire may comprise a conductive inner core having a rectangular cross section, an insulating layer arranged around the conductive inner core, and a surrounding layer arranged around the insulating layer.

The assembly may comprise a wire supply, such as a reel, comprising the wire, wherein at least during operating in the first and second mode, one end of the wire is coupled to the winding core, and another end of the wire is coupled to the wire supply.

Thermal contact conductance is the ratio between heat flow per unit area and temperature difference, across a contact surface between two solid bodies in thermal contact. The microscopic structure, e.g. roughness and non-flatness, of a typical thermal contact surface causes heat flow across it to be position dependent. Using thermal contact conductance is a way of capturing the average performance in a single value, typically written as h_{c} in the units W/m²K.

According to the present invention, consecutive layers of the edgewise wound coil are stacked radially. Because obtaining both a high stacking density and a good thermal conduction between layers is a priority, the layers are wound directly on top of each other. This results in consecutive layers having a thermal contact conductance between them of at least 1000 W/m2K.

The assembly of the present invention allows edgewise coils to be manufactured that display improved copper fill factors and thermal contact conductance despite the fact that relatively this wire is used. More in particular, the assembly of the present invention enables the proper handling of the wire, which, when used in prior art assemblies, would tend to wrinkle or otherwise deform in an unwanted manner.

According to a second aspect, the present invention provides a method for winding an edgewise coil, comprising the steps of providing a winding core and receiving a wire that has a substantially rectangular cross section. The winding core has a first end surface (E1) and a second end surface (E2) that are opposite to each other. The wire has first side surfaces and second side surfaces that correspond to short and long edges of the cross section, respectively.

The method further comprises the step of arranging the wire with one of its first side surfaces on the winding core for forming a first layer of the wire in a direction from the second end surface to the first end surface while simultaneously 1) guiding and bending, using a first wire guiding unit, the wire to follow a circumference of the winding core over an angle exceeding 30 degrees such that the first surfaces obtain a curvature that corresponds to a curvature of the winding core, 2) mutually rotating the winding core and the first guiding unit, and 3) pressing, using a first pressing unit, in a direction from the first end surface to the second end surface, onto a second side surface of the wire arranged on the winding core.

The method may further comprise the step of exerting a clamping force, using a first clamping member, in a direction from the first end surface to the second end surface, onto a second side surface of the wire arranged on the winding core after having arranged the first layer of wire on the winding core.

The wire may comprise a conductive inner core having a rectangular cross section, an insulating layer arranged around the conductive inner core, and a surrounding layer arranged around the insulating layer.

The method may further comprise the step of processing the surrounding layer such that different turns of the first layer become fixedly attached to each other. For example, the surrounding layer may comprise a thermoplastic material. The abovementioned processing may comprise heating the combination of the first clamping member and the winding core with the first layer to a temperature above the melting point of the thermoplastic material. In this manner, a single layer edgewise coil is formed.

Alternatively, the method may further comprise the step of arranging the wire with one of its first side surfaces on the winding core for forming a second layer of the wire on top of the first layer in a direction from the first end surface to the second end surface while simultaneously 1) guiding and bending, using a second wire guiding unit, the wire to follow the circumference of the winding core over an angle exceeding 30 degrees such that the first surfaces obtain a curvature that corresponds to a curvature of a combination of the winding core and the first layer of wire arranged on the winding core, 2) mutually rotating the winding core and the second guiding unit, and 3) pressing, using a second pressing unit, in a direction from the second end surface to the first end surface, onto a second side surface of the wire of the second layer arranged on the winding core.

The method may further comprise, after having arranged the second layer of wire on the winding core, exerting a clamping force, using a second clamping member, in a direction from the second end surface to the first end surface, onto a second side surface of the wire arranged on the winding core.

The method may further comprise processing the surrounding layer such that different turns of the first and second layers become fixedly attached to each other. The surrounding layer may comprise a thermoplastic material and said processing may comprise heating the combination of the first clamping member, the second clamping member, and the winding core with the first layer and second layer to a temperature above the melting point of the thermoplastic material.

According to a third aspect, the present invention provides a multi-layer edgewise coil comprising a winding core, and two or more layers of a wire arranged on the winding core. The wire has a substantially rectangular cross section, wherein the wire has first side surfaces and second side surfaces that correspond to short edges and long edges of the cross section, respectively. The wire is arranged with one of its first side surfaces on the winding core.

The wire comprises a conductive inner core having a rectangular cross section, and an insulating layer arranged around the conductive inner core. The coil comprises a body of surrounding material in which the conducive inner cores and insulating layers are fixated.

The winding core has a first end surface and a second end surface that are opposite to each other in a direction that is perpendicular to turns of the wire on the winding core. The coil comprises a first connector electrically connected to and/or formed by one end of the layers of wire and a second connector electrically connected to and/or formed by another end of the layers of wire, wherein the first connector and second connector extend from the body of surrounding material. The surrounding material may comprise thermoplastic material. In an embodiment, the multi-layer coil may comprise an even number of layers of wire. In this case, the first connector and second connector extend from the body of surrounding material near the second end surface of the winding core.

Next, the present invention described the present invention in more detail by referring to the appended drawings, wherein identical or similar components will be referred to using identical reference signs and wherein:

FIG. 1A illustrates a known edgewise coil and FIG. 1B illustrates a wire to be used in the coil of FIG. 1A;

FIG. 2A illustrates an embodiment of a dual-layer edgewise coil in accordance with the present invention and FIG. 2B illustrates a wire to be used in the coil of FIG. 2A;

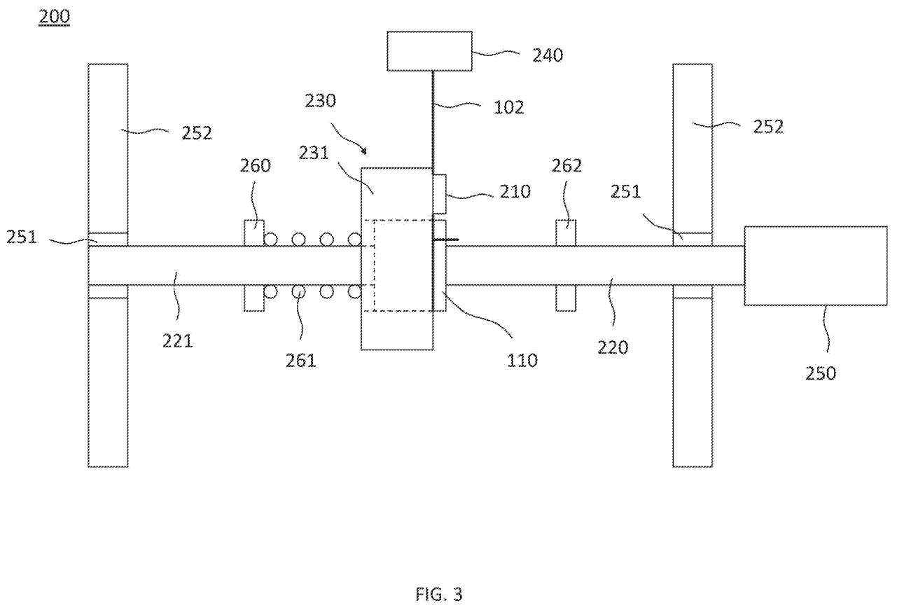

FIGS. 3-6 illustrate an embodiment of an assembly for winding the edgewise coil of FIG. 2A in accordance with the present invention; and

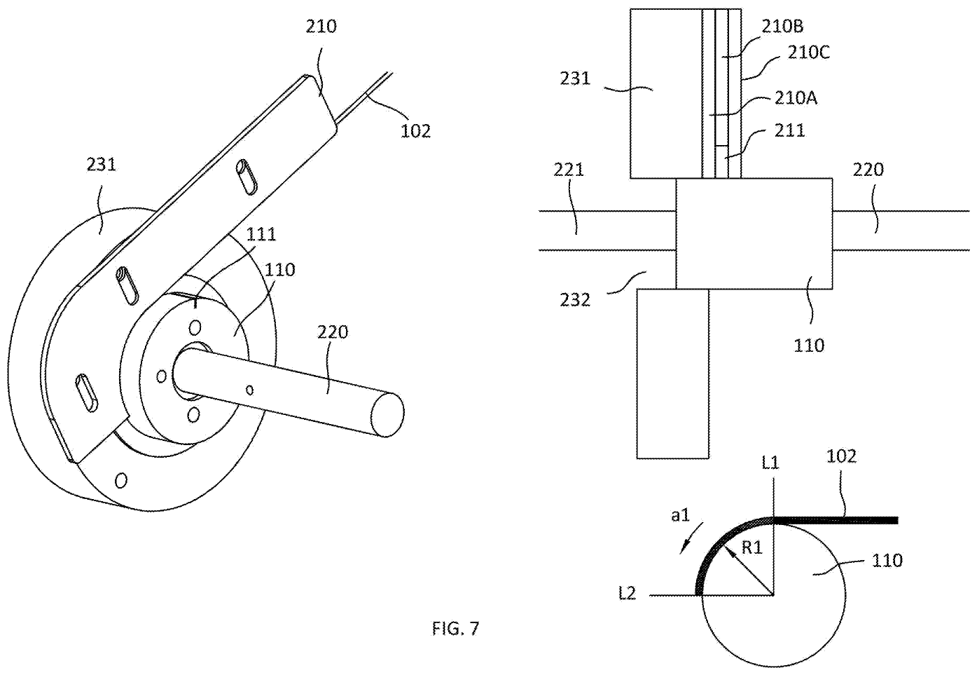

FIG. 7 illustrates various details of the wire guiding unit of the assembly of FIG. 3.

FIG. 2A illustrates an embodiment of a dual-layer edgewise coil 100 in accordance with the present invention. It comprises a winding core 110 and two layers of wire 102 wound with their first side surfaces 102A onto winding core 110. The different turns of coil 100 are arranged such that second side surfaces 102B of adjacently arranged segments of wire 102 touch each other.

Similar to wire 2, wire 102 comprises a conductive inner core 103 having a rectangular cross section, and an insulating layer 104 arranged around inner core 103. Wire 102 further comprises a surrounding layer 105 that is arranged around insulating layer 104. Surrounding layer 105 is typically made of a thermoplastic material. Typically, coil 100 is subjected to a heating step as a result of which surrounding layer 105 melts and forms a body of surrounding material in which inner cores 103 and insulation layers 104 are fixed.

Winding core 110 has a first end surface E1 and a second end surface E2 that are opposite to each other in a direction that is perpendicular to turns of wire 102 on winding core 110. Typically, winding core 110 has a cylindrical shape, with end surfaces E1 and E2 being axially separated and the abovementioned direction corresponding to an axis of cylinder. Furthermore, winding core 110 can be hollow or solid and can be made of steel, such as tool steel. Furthermore, winding core 110 may comprise multiple parts of which a first part is mechanically coupled to the drive shaft and wherein a second part of the winding core, which is arranged rotationally fixed around the first part at least during winding, receives the wire.

Coil 100 comprises a first connector C1 electrically connected to and/or formed by one end of the layers of wire 102 and a second connector C2 electrically connected to and/or formed by another end of the layers of wire 102. Therefore, a single continuous wire extends between connectors C1, C2.

First connector C1 and second connector C2 extend from body 105 of surrounding material near second end surface E2 of winding core 110. In the known single-layer edgewise coil 1 of FIG. 1A however, connectors C1 and C2 extend from the body of surrounding material near end surfaces E1, E2, respectively. For some applications, this makes the known coil more difficult to connect electrically.

FIGS. 3-6 illustrate an embodiment of an assembly 200 for winding edgewise coil 100 of FIG. 2A in accordance with the present invention. These figures will be used to describe the method of winding a dual-layer edgewise coil in accordance with the present invention.

As shown in FIG. 3, assembly 200 comprises a winding core 110, and a wire guiding unit 210 for receiving wire 102. Wire guiding unit 210 is configured for arranging wire 102 with one of its first side surfaces 102A on winding core 110.

Assembly 200 comprises a drive shaft 220 for rotating winding core 110 relative to wire guiding unit 210, and a pressing unit 230 that comprises a pressing body 231.

Wire guiding unit 210 is shown in more detail in FIG. 7, left, and top right. Wire guiding unit 210 comprises a first plate member 210A, a second plate member 210C, and an intermediate plate member 210B arranged in between first and second plate members 210A, 210C. As shown in FIG. 7, bottom right, wire guiding unit 210 comprises a channel 211 for guiding wire 102 that follows a circumference of winding core 110 over an angle a1 exceeding 30 degrees. Here, angle a1 is measured between axes L1, L2. Wire guiding unit 210 guides wire 102 at a radius R1 that equals the radius of winding core 110.

As shown in the cross section in FIG. 7, upper right, an end second section of first and second plate members 210A, 210C extends farther towards winding core 110 than intermediate plate member 210B. Mutually facing side surfaces of the end sections of the first and second plate members 210A, 210C form sidewalls of channel 211. An edge of intermediate plate 210B faces winding core 110 and forms an upper wall of channel 211. Winding core 110 forms a lower wall of channel 211. A size of the cross section of channel 211 corresponds to a size of wire 102.

Wire guiding unit 210 is fixedly attached to pressing unit 230. In some embodiments, first plate member 210A is omitted and a surface of pressing unit 230 defines the corresponding sidewall of channel 211. In other embodiments, wire guiding unit 210 is integrated in pressing unit 230.

Channel 211 of wire guiding unit 210 is configured for bending first surfaces 102A of wire 102 such that first surfaces 102A obtain a curvature that corresponds to a curvature of winding core 110. As shown in the side view of FIG. 7, bottom right, channel 211 follows a circumference of winding core 110 over an angle al that exceeds 60 degrees, more preferably 80 degrees.

Winding core 110 comprises a groove 111 in which an end of wire 102 can be clamped. This is performed at the start of the winding process and serves the fixate an end of wire 102 relative to winding core 110.

Now returning to FIG. 3, assembly 200 further comprises a wire supply 240 for supplying wire 102 and a supporting shaft 221 that is rotatably coupled to drive shaft 220 either directly or via winding core 110. Both shafts 221, 220 are supported using bearings 251 in walls 252 of a stationary frame. When drive shaft 220 is rotated by motor 250, auxiliary shaft 221, and winding core 110, which is fixedly connected to drive shaft 220 and/or auxiliary shaft 221, rotate relative to wire guiding unit 210. Typically, wire guiding unit 210 and wire supply 240 are kept stationary relative to walls 252 of the frame.

Auxiliary shaft 221 comprises spring supports 260 that support a spring 261. This latter spring exerts a spring force onto pressing body 231.

FIG. 3 illustrates assembly 200 working in a first mode. More in particular, FIG. 3 illustrates the start of winding a first layer of wire 102 onto winding core 110. To this end, a user has manually clamped wire 102 into groove 111 as shown in FIG. 7, left figure. Spring 261 is at or near its fully extended position and pressing body 231 presses against wire 102.

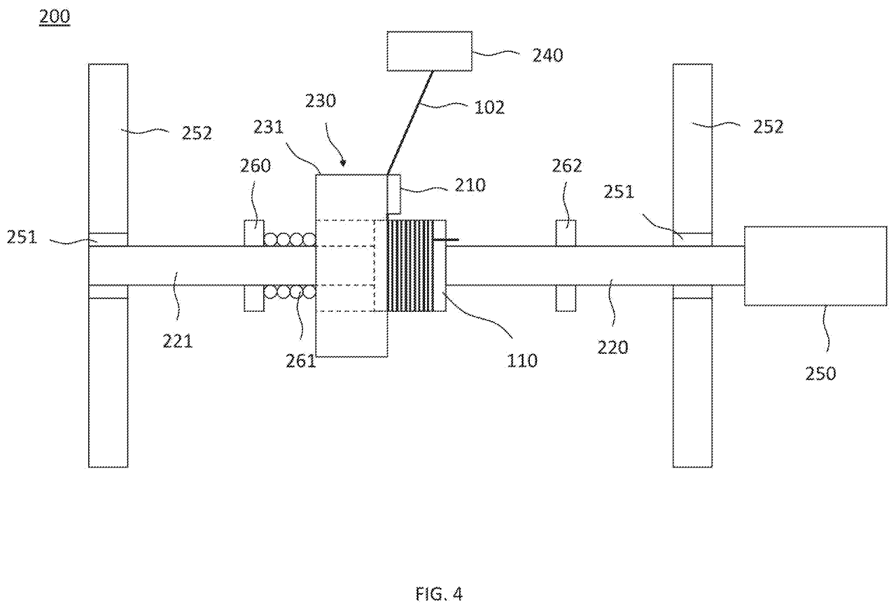

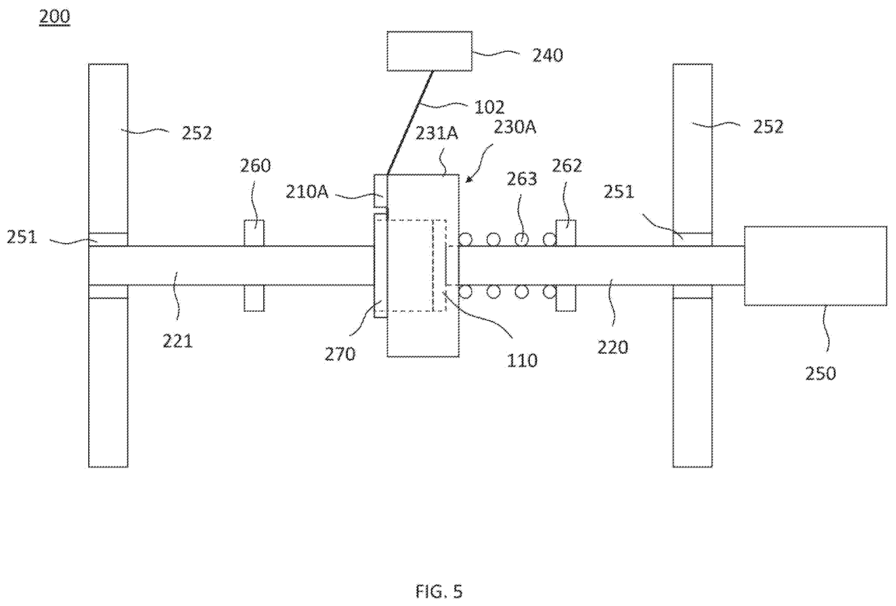

When drive shaft 220 rotates, more wire 102 will be arranged on winding core 110. The wire arranged on winding core 110 will push against pressing body 231. More in particular, pressing body 231 is pushed to the left by wire 102 in FIG. 3, against the spring force exerted by spring 261. Pressing body 231 comprises a central bore 232 in which first end surface E1 of winding core 110 is arranged during at least part of operating in the first mode. As a result of wire 102 on winding core 110 pushing against pressing body 231, more of winding core 110 will emerge out of central bore 232. At the end of winding the first layer of wire 102, as illustrated in FIG. 4, most of winding core 110 will be located outside central bore 232.

After having wound a first layer of wire 102 onto winding core 110, auxiliary shaft 221 is decoupled from drive shaft 220 and/or winding core 110 and spring 261 is removed. In addition, pressing body 231 is removed and a clamping member 270 is mounted at or near first end E1 of winding core 110. The purpose of mounting clamping member 270 is to maintain a certain amount of axially force onto wire 102.

In addition, drive shaft 220 is decoupled from winding core 110, and a further pressing unit 230A having a pressing body 231A and further wire guiding unit 210A are mounted. In addition, a spring 263 is arranged around drive shaft 220, which, after coupling drive shaft 220 again to winding core 110, causes pressing body 231A to exert a pressing force onto wire 102, albeit from an opposite direction as pressing body 231. Next, assembly 200 will operate in a second mode.

In the second mode, a second layer of wire 102 will be wound onto the first layer of wire 102. During winding of the second layer, pressing body 231A continuously exerts a force onto wire 102 using spring 263. More in particular, pressing body 231A moves to the right in FIG. 5 as a result of the second layer of wire 102 pushing against pressing body 231A.

It is noted that further wire guiding unit 210A and wire guiding unit 210 are configured similarly. The same holds for further pressing body 231A and pressing body 231. The central bore of further pressing body 231A should have an inner diameter that corresponds to the diameter of winding core 110 and a single layer of wire 102. Central bore 232 of pressing body 231 should have an inner diameter that corresponds to the diameter of winding core 110. In this manner, it is ensured that, when operating in the second mode, the wire of the second layer is pressed against while that part of winding core 110 on which only the first layer of wire 102 is arranged is able to move inside the central bore of pressing body 231A. In this manner, it is also ensured that, when operating in the third mode, the wire of the first layer is pressed against while that part of winding core 110 on which no wire 102 is arranged is able to move inside the central bore of pressing body 231.

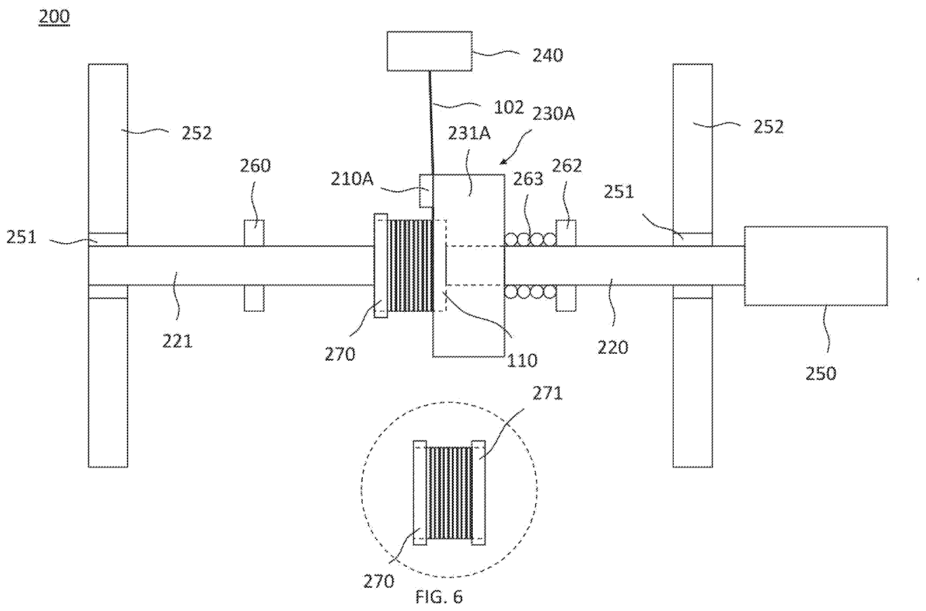

Similarly, the channel of further wire guiding unit 210A should be adapted as wire 102 should be arranged on the first layer of wire 102. Furthermore, wire 102 should be guided at a slightly larger radius, namely the sum of the radius of winding core 110 and the thickness of wire 102. Both aspects have an impact on the first and second plate members and on the intermediate plate member of further wire guiding unit 210A. After winding the second layer of wire 102, a situation is obtained as shown in FIG. 6. As a next step, drive shaft 220 will be decoupled from winding core 110, and further pressing body 231A, further wire guiding unit 210A, and spring 263 will be removed. Then, a second clamping member 271 will be arranged to ensure that sufficient clamping force is exerted onto wire 102 even though further pressing body 231A has been removed. In addition, auxiliary shaft 221 will be decoupled from winding core 110 so that a user may remove winding core 110 from the remainder of the system. Prior to removing winding core 110, wire 102 is cut so that it is no longer coupled to wire supply 240. Winding core 110 with clamping members 270, 271 is shown in the hashed circle in FIG. 6.

After removing winding core 110 from the system, it is heated to allow the thermoplastic material to melt thereby fixating inner cores 103 and insulating layers 104 relative to winding core 110. In some embodiments, winding core 110 is removed after solidification of the thermoplastic material as the solidified thermoplastic material provides sufficient strength, whereas in other embodiments winding core 110 remains attached.

In the embodiment shown in FIGS. 3-6, a dual-layer edgewise coil is formed. However, the present invention is not limited thereto. More in particular, after having arranged the second layer of wire 102, a third layer could be arranged using an even further wire guiding unit and an even further pressing unit of which the dimensioning should be adapted relative to wire guiding unit 210 and pressing unit 230 to account for the fact that already two layers of wire 102 are present on winding core 110. It should be apparent to the skilled person that this process can be repeated to achieve any desired number of layers of wire 102. By using an even number of layers, it becomes possible to have the ends of wire 102 at the same end surface of winding core 110. In this manner, it is not required to route one end of wire 102 to the other side of the coil. It should however be noted that the present invention equally applies to coils having an odd number of layers greater than one.

In the above, the present invention has been explained using detailed embodiments thereof. However, the present invention is not limited to these embodiments. Rather, various modifications are possible without deviating from the scope of the present invention, which is defined by the appended claims and their equivalents.

1. An assembly for winding an edgewise coil, comprising:
a winding core;
at least one wire guiding unit for receiving a wire that has a substantially rectangular cross section, said wire having first side surfaces and second side surfaces that correspond to short edges and long edges of the cross section, respectively, and wherein the at least one wire guiding unit is configured for arranging the wire with one of its first side surfaces on the winding core;
a drive shaft for rotating the winding core relative to the at least one wire guiding unit, wherein the winding core has a first end surface and a second end surface that are opposite to each other in a direction parallel to the drive shaft; and
a first pressing unit,
wherein the at least one wire guiding unit comprises a channel for guiding the wire that follows at least a part of a circumference of the winding core, preferably over an angle exceeding 30 degrees;
wherein the assembly is configured for operating in a first mode in which mode the first pressing unit presses, in a direction from the first end surface to the second end surface, onto a second side surface of the wire arranged on the winding core at least during winding of a first layer of the wire on the winding core by means of rotating the winding core relative to the at least one wire guiding unit.

2. The assembly according to claim 1, wherein the channel follows a circumference of the winding core over an angle that exceeds 60 degrees, more preferably 80 degrees.

3. The assembly according to claim 1, wherein a size of the cross section of the channel corresponds to a size of the wire.

4. The assembly according to claim 1, wherein the at least one wire guiding unit comprises a first wire guiding unit of which the channel is configured for bending the first surfaces of the wire such that the first surfaces obtain a curvature that corresponds to a curvature of the winding core,
wherein the first wire guiding unit comprises a groove in a bottom surface of the first wire guiding unit that faces the winding core, said groove forming the channel of the first wire guiding unit, and
wherein the first wire guiding unit comprises a first plate member, a second plate member, and a first intermediate plate member arranged in between the first and second plate members, wherein an end second section of the first and second plate members extends farther towards the winding core than the first intermediate plate member, wherein mutually facing side surfaces of the end sections of the first and second plate members form sidewalls of the channel, wherein an edge of the first intermediate plate facing the winding core forms an upper wall of the channel and the winding core a lower wall of the channel when the assembly operates in the first mode.

5. (canceled)

6. (canceled)

7. The assembly according to claim 4, wherein the first wire guiding unit is fixedly attached to the first pressing unit,
wherein the first pressing unit comprises a first pressing body having a first central bore in which the first end surface of the winding core is arranged during at least part of operating in the first mode, and a first spring for exerting a spring force onto the first pressing body, and
wherein the first pressing body is configured, when the assembly operates in the first mode, to be pushed by the wire that is arranged on the winding core in the direction from the second end surface to the first end surface thereby compressing the first spring.

8.-11. (canceled)

12. The assembly according to claim 7, further comprising:
a first spring support mounted to the supporting shaft when the assembly operates in the first mode, wherein the first spring is mounted in between the first spring support and the first pressing unit when the assembly operates in the first mode; and
a supporting shaft that is rotationally coupled to the drive shaft,
wherein the supporting shaft can be decoupled from the drive shaft.

13. The assembly according to claim 1, wherein the assembly is operable in a second mode following the first mode, the assembly further comprising:
a first clamping member mounted to or at the first end surface of the winding core at least when the assembly operates in the second mode, wherein the first clamping member is configured to exert a clamping force, in a direction from the first end surface to the second end surface, onto a second side surface of the wire arranged on the winding core, and
a second pressing unit, wherein, when the assembly operates in the second mode, the second pressing unit presses, in a direction from the second end surface to the first end surface, onto a second side surface of the wire arranged on the winding core at least during winding of a second layer of the wire on the winding core by means of rotating the winding core.

14. (canceled)

15. The assembly according to claim 13, wherein the at least one guiding unit comprises a second wire guiding unit of which the channel is configured for bending the first surfaces of the wire such that the first surfaces obtain a curvature that corresponds to a curvature of the combination of the winding core and the first layer of wire arranged on the winding core,
wherein the second wire guiding unit comprises a groove in a bottom surface of the second wire guiding unit that faces the winding core, said groove forming the channel of the second wire guiding unit, and
wherein the second wire guiding unit comprises a third plate member, a fourth plate member, and a second intermediate plate member arranged in between the third and fourth plate members, wherein an end second section of the third and fourth plate members extends farther towards the winding core than the second intermediate plate member, wherein mutually facing side surfaces of the end sections of the third and fourth plate members form sidewalls of the channel, wherein an edge of the second intermediate plate facing the winding core forms an upper wall of the channel and the first layer of the wire arranged on the winding core a lower wall of the channel when the assembly operates in the second mode.

16. (canceled)

17. (canceled)

18. The assembly according to claim 15, wherein the second wire guiding unit is fixedly attached to the second pressing unit,
wherein the second pressing unit comprises a second pressing body having a second central bore in which the second end surface of the winding core is arranged during at least part of operating in the second mode, and a second spring for exerting a spring force onto the second pressing body, and
wherein the second pressing body is configured, when the assembly operates in the second mode, to be pushed by the wire that is arranged on the winding core in the direction from the first end surface to the second end surface thereby compressing the second spring.

19. (canceled)

20. (canceled)

21. The assembly according to claim 18, further comprising a second spring support mounted to the drive shaft when the assembly operates in the second mode, wherein the second spring is mounted in between the second spring support and the second pressing unit when the assembly operates in the second mode.

22. The assembly according to claim 1, wherein the assembly is operable in a third mode in which the second pressing unit has been removed from the second end surface of the winding core, the assembly further comprising a second clamping member mountable to or at the second end surface of the winding core, wherein the second clamping member is configured to exert a clamping force, in a direction from the second end surface to the first end surface, onto a second side surface of the wire arranged on the winding core at least during operating in the second mode.

23. The assembly according to claim 1, wherein the winding core comprises a groove for allowing an end of the wire to be clamped prior to operating in the first mode, and
wherein the wire comprises a conductive inner core having a rectangular cross section, an insulating layer arranged around the conductive inner core, and a surrounding layer arranged around the insulating layer.

24. (canceled)

25. The assembly according to claim 1, comprising a wire supply, such as a reel, comprising the wire, wherein at least during operating in the first and second mode, one end of the wire is coupled to the winding core, and another end of the wire is coupled to the wire supply.

26. A method for winding an edgewise coil, comprising:
providing a winding core, wherein the winding core has a first end surface and a second end surface that are opposite to each other;
receiving a wire that has a substantially rectangular cross section, said wire having first side surfaces and second side surfaces that correspond to short and long edges of the cross section, respectively;
arranging the wire with one of its first side surfaces on the winding core for forming a first layer of the wire in a direction from the second end surface to the first end surface while simultaneously:
guiding and bending, using a first wire guiding unit, the wire to follow a circumference of the winding core, preferably over an angle exceeding 30 degrees, such that the first surfaces obtain a curvature that corresponds to a curvature of the winding core, the wire having a substantially rectangular cross section, said wire having first side surfaces and second side surfaces that correspond to short edges and long edges of the cross section, respectively, the first guiding unit being is configured for arranging the wire with one of its first side surfaces on the winding core;
mutually rotating the winding core and the first guiding unit; and
pressing, using a first pressing unit, in a direction from the first end surface to the second end surface, onto a second side surface of the wire arranged on the winding core.

27. The method according to claim 26, further comprising, after having arranged the first layer of wire on the winding core, exerting a clamping force, using a first clamping member, in a direction from the first end surface to the second end surface, onto a second side surface of the wire arranged on the winding core.

28. The method according to claim 27, wherein the wire comprises a conductive inner core having a rectangular cross section, an insulating layer arranged around the conductive inner core, and a surrounding layer arranged around the insulating layer, the method further comprising processing the surrounding layer such that different turns of the first layer become fixedly attached to each other,
wherein the surrounding layer comprises a thermoplastic material, and wherein said processing comprises heating the combination of the first clamping member and the winding core with the first layer to a temperature above the melting point of the thermoplastic material, and
wherein the method further comprises arranging the wire with one of its first side surfaces on the winding core for forming a second layer of the wire on top of the first layer in a direction from the first end surface to the second end surface while simultaneously:
guiding and bending, using a second wire guiding unit, the wire to follow the circumference of the winding core over an angle exceeding 30 degrees such that the first surfaces obtain a curvature that corresponds to a curvature of a combination of the winding core and the first layer of wire arranged on the winding core;
mutually rotating the winding core and the second guiding unit; and
pressing, using a second pressing unit, in a direction from the second end surface to the first end surface, onto a second side surface of the wire of the second layer arranged on the winding core.

29. (canceled)

30. (canceled)

31. The method according to claim 28, further comprising, after having arranged the second layer of wire on the winding core, exerting a clamping force, using a second clamping member, in a direction from the second end surface to the first end surface, onto a second side surface of the wire arranged on the winding core,
wherein the wire comprises a conductive inner core having a rectangular cross section, an insulating layer arranged around the conductive inner core, and a surrounding layer arranged around the insulating layer, the method further comprising processing the surrounding layer such that different turns of the first and second layers become fixedly attached to each other, and
wherein the surrounding layer comprises a thermoplastic material, and wherein said processing comprises heating the combination of the first clamping member, the second clamping member, and the winding core with the first layer and second layer to a temperature above the melting point of the thermoplastic material.

32. (canceled)

33. (canceled)

34. A multi-layer edgewise coil comprising a winding core, and two or more layers of a wire arranged on the winding core, wherein the wire has a substantially rectangular cross section, wherein the wire has first side surfaces and second side surfaces that correspond to short edges and long edges of the cross section, respectively, and wherein the wire is arranged with one of its first side surfaces on the winding core,
wherein the wire comprises a conductive inner core having a rectangular cross section, and an insulating layer arranged around the conductive inner core,
wherein the coil comprises a body of surrounding material in which the conductive inner cores and insulation layers are fixated,
wherein the winding core has a first end surface and a second end surface that are opposite to each other in a direction that is perpendicular to turns of the wire on the winding core,
wherein the coil comprises a first connector electrically connected to and/or formed by one end of the layers of wire and a second connector electrically connected to and/or formed by another end of the layers of wire,
wherein the first connector and second connector extend from the body of surrounding material, and
wherein the wire has a width, corresponding to the long edges of the cross section, that lies in a range between 0.5 and 6 mm, preferably in a range between 1 and 3 mm, and wherein the wire has a thickness, corresponding to the short edges of the cross section, that lies in between 0.05 and 1 mm, preferably between 0.1 and 0.5 mm.

35. The multi-layer coil according to claim 34, wherein a thermal contact conductance between adjacently arranged layers of wire exceeds 1000 W/m²K,
wherein the two or more layers of wire are an even number of layers, wherein the first connector and second connector extend from the body of surrounding material near the second end surface of the winding core, and
wherein the surrounding material comprises thermoplastic material.

36. (canceled)

37. (canceled)
